(19) United States
(12) Patent Application Publication
(10) Pub. No.: US 2025/0168862 A1
(43) Pub. Date: May 22, 2025

(54) CHANNEL ACCESS PROCEDURE SELECTION FOR SIDELINK COMMUNICATIONS IN AN UNLICENSED SPECTRUM

(71) Applicant: Fraunhofer-Gesellschaft zur Förderung der angewandten Forschung e.V., München (DE)

(72) Inventors: Sarun SELVANESAN, Berlin (DE); Thomas WIRTH, Berlin (DE)

(21) Appl. No.: 19/029,091

(22) Filed: Jan. 17, 2025

Related U.S. Application Data
(63) Continuation of application No. PCT/EP2023/070583, filed on Jul. 25, 2023.

(30) Foreign Application Priority Data
Jul. 28, 2022 (EP) 22187433.2

(51) Int. Cl. H04W 72/25; H04L 5/00

(52) U.S. Cl. CPC H04W 72/25; H04L 5/0092

(57) ABSTRACT

A user device, UE, for a wireless communication network, like a 3^{rd} Generation Partnership Project, 3GPP, network, is described. The UE is to communicate with one or more further UEs in the wireless communication network over a sidelink, SL, using a set of resources in an unlicensed spectrum. For performing a SL transmission on the set of resources in the unlicensed spectrum, the UE is to perform a channel access procedure, CAP, for evaluating an availability of the set of resources for performing the SL transmission. The UE is to select the CAP to be used for evaluating the availability of the set of resources for performing the SL transmission based on a criterion.

### CROSS-REFERENCE TO RELATED APPLICATIONS

This application is a continuation of copending International Application No. PCT/EP2023/070583, filed Jul. 25, 2023, which is incorporated herein by reference in its entirety, and additionally claims priority from European Application No. 22187433.2, filed Jul. 28, 2022, which is also incorporated herein by reference in its entirety.

### TECHNICAL FIELD

The present invention concerns the field of wireless communication systems or networks, more specifically, a direct communication between user devices over a sidelink using resources in the unlicensed spectrum. Embodiments concern the selection of channel access procedures for such a sidelink communication in the unlicensed spectrum.

### BACKGROUND OF THE INVENTION

FIG. 1 is a schematic representation of an example of a terrestrial wireless network 100 including, as is shown in FIG. 1(a), the core network 102 and one or more radio access networks RAN₁, RAN₂, . . . RAN_{N}. FIG. 1(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user device or user equipment, that are in cell 106₂ and that are served by base station gNB₂. Another user UEs is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UEs as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1(b) by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116₁ to 116₅, which are schematically represented in FIG. 1(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st} stage SCI, and optionally, a second control region which contains a second part of control information, also referred to as the 2^{nd} stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with 3GPP's LTE, LTE-Advanced, LTE-Advanced Pro standard, or the 5G or 3GPP NR, New Radio, standard, or within NR-U, New Radio Unlicensed, which is specified within the aforementioned LTE and NR specifications.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above-described terrestrial wireless network also non-terrestrial wireless communication networks, NTN, exist including space-borne transceivers, like satellites, and/or airborne transceivers, like unmanned aircraft systems. The non-terrestrial wireless communication network or system may operate in a similar way as the terrestrial system described above with reference to FIG. 1, for example in accordance with LTE-Advanced Pro specifications or the 5G or NR, New Radio, specifications.

In mobile communication networks, for example in a network like that described above with reference to FIG. 1, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station or different base stations so that the base station may provide sidelink resource allocation configuration or assistance for the UEs. For example, both UEs may be within the coverage area of a base 10 station, like one of the base stations depicted in FIG. 1. This is referred to as an “in-coverage” scenario. Another scenario is referred to as an “out-of-coverage” scenario. It is noted that “out-of-coverage” does not mean that the two UEs are necessarily outside one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or 20
may be connected to the base station that may not support NR V2X services, e.g., GSM, UMTS, LTE base stations.

FIG. 2(a) is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X. Thus, in Mode 1, a SL UE, e.g., UE 202 is connected via Uu interface to the gNB, and the gNB coordinates the resources for UE 202 be used to transmit control and/or data to another UE, e.g., UE 204, via a SL interface, which is referred to in NR as PC5.

FIG. 2(b) is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 2(b) which is the out-of-coverage scenario does not necessarily mean that the respective mode 2 UEs in NR or mode 4 UEs in LTE are outside of the coverage 200 of a base station, rather, it means that the respective mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 2(a), in addition to the NR mode 1 or LTE mode 3 UEs 202, 204 also NR mode 2 or LTE mode 4 UEs 206, 208, 210 are present. In addition, FIG. 2(b), schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210. Thus, the SL UEs, e.g., UEs 206-210, need not to have a connectivity to the gNB, and perform a sensing & access resource allocation or a random access-based resource allocation, e.g., when transmitting from UE 206 to UE 208. Nevertheless, basic configurations need to be available for the UEs 206-210, in order to successfully exchange data. This information may be pre-configured or may be configured while a UE is within coverage of the gNB. For this the gNB may provide a basic configuration, e.g., basic information, which may be transported via a broadcast channel, e.g., using system information blocks (SIBs). The BS may also assist Mode 2 UEs to provide basic information on which resource pool (RP) is to be used or may act as a synchronization source.

Although FIG. 2(a) and FIG. 2(b) illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

In the above-described scenarios of vehicular user devices, UEs, a plurality of such user devices may form a user device group, also referred to simply as group, and the communication within the group or among the group members may be performed via the sidelink interfaces between the user devices, like the PC5 interface. For example, the above-described scenarios using vehicular user devices may be employed in the field of the transport industry in which a plurality of vehicles being equipped with vehicular user devices may be grouped together, for example, by a remote driving application. Other use cases in which a plurality of user devices may be grouped together for a sidelink communication among each other include, for example, factory automation and electrical power distribution. In the case of factory automation, a plurality of mobile or stationary machines within a factory may be equipped with user devices and grouped together for a sidelink communication, for example for controlling the operation of the machine, like a motion control of a robot. In the case of electrical power distribution, entities within the power distribution grid may be equipped with respective user devices which, within a certain area of the system may be grouped together so as to communicate via a sidelink communication with each other so as to allow for monitoring the system and for dealing with power distribution grid failures and outages.

It is noted that the information in the above section is only for enhancing the understanding of the background of the invention and, therefore, it may contain information that does not form conventional technology that is already known to a person of ordinary skill in the art.

### SUMMARY

An embodiment may have a user device, UE, for a wireless communication network, like a 3^{rd} Generation Partnership Project, 3GPP, network, wherein the UE is to communicate with one or more further UEs in the wireless communication network over a sidelink, SL, using a set of resources in an unlicensed spectrum, wherein, for performing a SL transmission on the set of resources in the unlicensed spectrum, the UE is to perform a channel access procedure, CAP, for evaluating an availability of the set of resources for performing the SL transmission, and wherein the UE is to select the CAP to be used for evaluating the availability of the set of resources for performing the SL transmission based on a criterion.

Another embodiment may have a wireless communication system, like a 3^{rd} Generation Partnership Project, 3GPP, system, having a one or more user devices, UEs, and one or more base stations, wherein the UE is to communicate with one or more further UEs in the wireless communication network over a sidelink, SL, using a set of resources in an unlicensed spectrum, wherein, for performing a SL transmission on the set of resources in the unlicensed spectrum, the UE is to perform a channel access procedure, CAP, for evaluating an availability of the set of resources for performing the SL transmission, and wherein the UE is to select the CAP to be used for evaluating the availability of the set of resources for performing the SL transmission based on a criterion.

According to another embodiment, a method for operating a user device, UE, for a wireless communication network, like a 3^{rd} Generation Partnership Project, 3GPP, network, may have the steps of: communicating, by the UE, with one or more further UEs in the wireless communication network over a sidelink, SL, using a set of resources in an unlicensed spectrum, for performing a SL transmission on the set of resources in the unlicensed spectrum, performing, by the UE, a channel access procedure, CAP, for evaluating an availability of the set of resources for performing the SL transmission, and selecting, by the UE, the CAP to be used for evaluating the availability of the set of resources for performing the SL transmission based on a criterion.

### BRIEF DESCRIPTION OF THE DRAWINGS

Embodiments of the present invention are now described in further detail with reference to the accompanying drawings, in which:

FIG. 1(a) is a schematic representation of an example of a terrestrial wireless network;

FIG. 1(b) is a schematic representation of an example of a terrestrial wireless network;

FIG. 2(a) is a schematic representation of an in-coverage scenario;

FIG. 2(b) is a schematic representation of an out-of-coverage scenario;

FIG. 3 is a schematic representation of a wireless communication system including a transmitter, like a base station, and one or more receivers, like user devices, UEs, implementing embodiments of the present invention;

FIG. 4 illustrates a user device, UE, in accordance with an embodiment of the present invention;

FIG. 5 illustrates an embodiment how a failed initial CAP may be handled for a data transmission over the SL having a certain PDB, and

FIG. 6 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

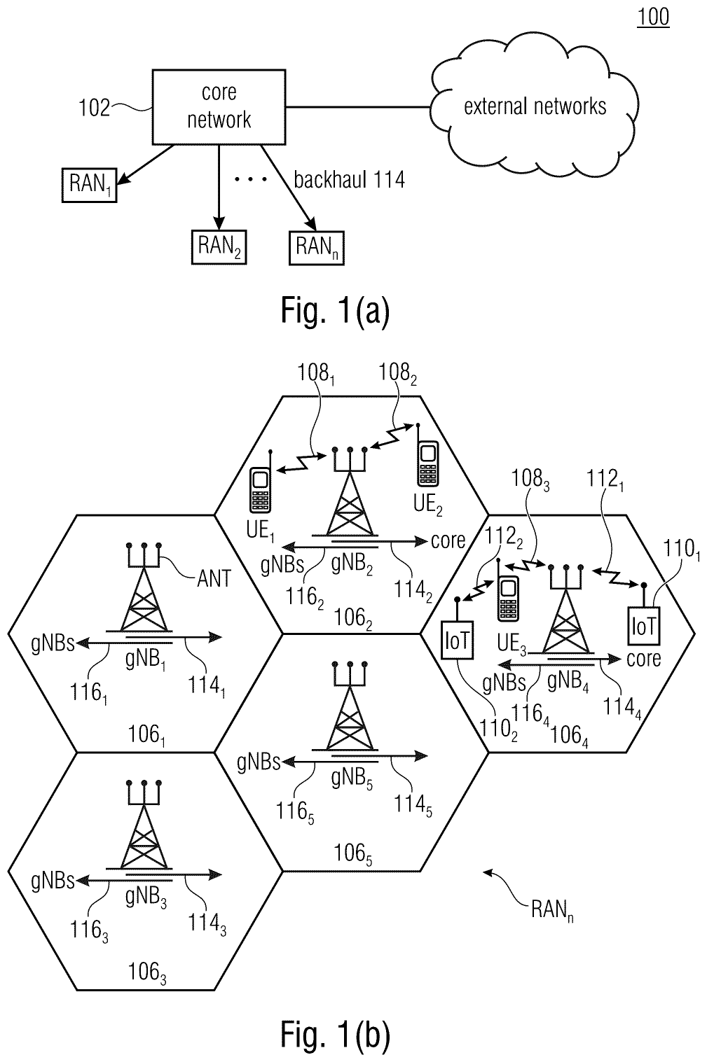

In mobile communication systems or networks, like those described above with reference to FIG. 1, for example in a LTE or 5G/NR network, the respective entities may communicate using one or more frequency bands. A frequency band includes a start frequency, an end frequency and all intermediate frequencies between the start and end frequencies. In other words, the start, end and intermediate frequencies may define a certain bandwidth, e.g., 20 MHz. A frequency band may also be referred to as a carrier, a bandwidth part, BWP, a subband, a resource pool and the like.

When using a single frequency band, the communication may be referred to as a single-band operation, e.g., a UE transmits/receives radio signals to/from another network entity on frequencies being within the band, like the 20 MHz band.

When using a two or more frequency bands, the communication may be referred to as a multi-band operation or as a wideband operation or as a carrier aggregation operation. The frequency bands may have different bandwidths or the same bandwidth, like 20 MHz. For example, in case of frequency bands having the same bandwidths, a UE may transmit/receive radio signals to/from another network entity on frequencies being within two or more of the 20 MHz bands so that the frequency range for the radio communication may be a multiple of 20 MHz. The two or more frequency bands may be continuous/adjacent frequency bands or some or all for the frequency bands may be separated in the frequency domain.

The multi-band operation may include frequency bands in the licensed spectrum, or frequency bands in the unlicensed spectrum, or frequency bands both in the licensed spectrum and in the unlicensed spectrum.

Carrier aggregation, CA, is an example using two or more frequency bands in the licensed spectrum and/or in the unlicensed spectrum. Also mixed combinations are possible, e.g., one or more frequency bands in licensed and one or more frequency bands in unlicensed bands. Furthermore, CA may also be just used for aggregation of an additional carrier in one direction, e.g., as a supplemental carrier to improve transmissions via UL, DL or SL.

5G New Radio (NR) may support an operation in the unlicensed spectrum so that a single-band operation or a multi-band operation may include frequency bands or subbands or resource pools in the unlicensed spectrum. The unlicensed spectrum may include bands with a potential IEEE 802.11 coexistence, such as frequency bands within the 5 GHz and/or the 6 GHz spectrum. NR-U may support bandwidths that are an integer multiple of 20 MHz, for example due to regulatory requirements. The splitting into the subbands may be performed so as to minimize interference with coexisting systems, like IEE 802.11 systems, which may operate in one or more of the same bands with the same nominal bandwidth channels, like 20 MHz channels. Other examples of coexisting systems may use subbands having subband sizes and nominal frequencies different from the above-described IEEE 802.11 systems. For example, the unlicensed spectrum may include the 5 GHz band, the 6 GHz band, the 24 GHz band or the 60 GHz band. Examples of such unlicensed bands include the industrial, scientific and medical, ISM, radio bands reserved internationally for the use of radio frequency energy for industrial, scientific and medical purposes other than telecommunications.

During an operation using unlicensed subbands, Listen-before-talk, LBT, may be performed separately per subband. This may lead to a situation in which one or more of the subbands are busy or occupied due to an interference, for example, from other communication systems coexisting on the same band, like other public land mobile networks, PLMNs or systems operating in accordance with the IEEE 802.11 specification or operating under the ETSI Broadband Radio Access Networks, BRAN, specifications. In such a situation, the transmitter, either the transmitting gNB or the transmitting UE, is only allowed to transmit on the subbands which are detected to be not busy, also referred to as subbands being free or non-occupied. For example, for a transmission spanning more than 20 MHz in the 5 GHz operational unlicensed band, the transmitter, like the gNB or the UE, performs Listen-Before-Talk, LBT, separately on each subband. Once the LBT results are available for each subband, the devices, for example, the gNB in the downlink, DL, or the UE in the uplink, UL, are allowed to transmit on those subbands which are determined to be free or unoccupied, i.e., to transmit on the won subband(s). No transmission is allowed on the occupied, busy, or non-won subbands.

For accessing resources or channels in the unlicensed spectrum, a so-called NR-U channel access is to be performed, which makes use of a channel access procedure, which is a procedure based on sensing that evaluates the availability of a channel for performing transmissions. The basic unit for sensing may be a sensing slot with a certain duration, e.g., Tₛᵢ=9 μs. The sensing slot duration Tₛᵢ is considered to be idle if a base station or a UE senses the channel during the sensing slot duration and determines that the detected power is less than an energy detection threshold for at least a certain time, like 4 us within the sensing slot duration. Otherwise, the sensing slot duration is considered to be busy. In case a channel is available or not busy, one or more transmissions may be performed on the channel, and the so-called channel occupancy refers to the one or more transmissions on the one or more channels by the base station or UE after performing the corresponding channel access procedure. A channel occupancy time refers to the total time for which the base station or UE and any other base station or UE may share the channel occupancy to perform one or more transmissions on the channel after the base station or UE has performed the channel access procedure. For determining a channel occupancy time, if a transmission gap is less than or equal to a certain period, like 25 μs, the gap duration is counted in the channel occupancy time. A channel occupancy time may be shared for a transmission between a base station and a corresponding UE.

Several types of channel access procedures, CAPs, may exist, e.g.:
Type-1 CAP The time duration for which the sensed channel has to be idle before the transmission may be random. For example, a base station or a UE may determine an initial counter N which is randomly selected to be between 0 and contention window,CWₚ, where CW_{min,p}≤CWₚ≤CW_{max,p}, with CW_{min,p} and CW_{max,p} being subject to the channel access procedure class, CAPC. When the channel is sensed to be idle for a certain period of time, the value of N is decremented, and a transmission may take place only once N reaches 0.
Type-2A: The time duration for which the sensed channel has to be idle before the transmission may be deterministic, and the channel may need to be idle for a sensing interval of a first duration, like 25 μs.
Type-2B: The time duration for which the sensed channel has to be idle before the transmission may be deterministic, and the channel may need to be idle for a sensing interval of a second duration shorter than the first duration, like 16 us.
Type-2C: This type does not perform any sensing of the channel before the transmission, and the duration of a corresponding transmission may have a predefined duration, e.g. may be at most 583 us.

For downlink, DL, multiple-channel accesses, respective types of DL multi-channel access procedures may exist, e.g.:
Type-A: This type requires the base station to perform a Type 1 LBT on each channel.
Type-B: This type requires the base station to perform a Type 1 LBT on one of the multiple channels and sense the other channels for at least a sensing interval of a certain duration, like 25 us, before performing a transmission, optionally with the constraint that a selection of channels may be random or a selection of the channel may not be more frequent than once every 1 second.

For uplink, UL, multi-channel access procedures, a UE is either scheduled to start a transmission on channels as indicated by the base station or is to perform an uplink transmission on configured resources. The UE only performs a single-channel sensing or access procedure, for example, of Type 1 or Type 2, on a certain channel as indicated by the base station.

The following table illustrates the scenarios for UEs to use different channel access procedures, more specifically, in what scenarios or situations the UE uses the Type 1 channel access procedure or the Type 2 channel access procedure for the PUSCH.

| UE uses Type 1 for PUSCH | When UE uses Type 2 for PUSCH |
|---|---|
| in case the UL grant indicates that the | in case the UL grant indicates that the |
| Type 1 CAP is to be used | Type 2 CAP is to be used |
| in case of transmitting one or more | in case of transmitting one or more |
| transmissions which include an | reference signal transmissions based |
| autonomous or configured grant | on a DL assignment that indicates to the |
| PUSCH transmission on configured UL | UE to use Type 2, and triggers a |
| resources | sounding reference signal, SRS |
| | transmission, but does not schedule a |
| | PUCCH transmission. |
| | In this case, the gNB requests the UE to |
| | transmit a SRS to estimate the CSI over |
| | a range of frequencies. For the UE to |
| | transmit this SRS, the gNB provides a |
| | DL assignment that indicates the UE to |
| | use Type 2 for the transmission of the |
| | SRS back to the gNB. There is no data |
| | transmission here, only a reference |
| | signal transmission. |
| in case of transmitting one or more SRS | |
| transmissions not including a PUSCH | |
| transmission and an UL channel access | |
| priority class p = 1 | |
| if the UE is scheduled by the gNB to | if the UE is scheduled by the gNB to |
| transmit the PUSCH and one or more | transmit the PUSCH and one or more |
| SRSs by a single UL grant in non- | SRSs by a single UL grant in non- |
| contiguous transmissions, or if the UE | contiguous transmissions, or if the UE |
| is scheduled by the gNB to transmit the | is scheduled by the gNB to transmit the |
| PUCCH and/or SRSs by a single DL | PUCCH and/or SRSs by a single DL |
| assignment in non-contiguous | assignment in non-contiguous |
| transmissions, the UE shall use the | transmissions, the UE shall use the |
| channel access procedure indicated by | channel access procedure indicated by |
| the scheduling DCI for the first UL | the scheduling DCI for the first UL |
| transmission scheduled by the | transmission scheduled by the |
| scheduling DCI. | scheduling DCI. |
| if the channel sensed by the UE is | if the channel is sensed by the UE to |
| not continuously idle after the UE | be continuously idle after the UE has |
| has stopped transmitting the first UL | stopped transmitting the first |
| transmission or the further UL | transmission, the UE may transmit |
| transmissions are outside the gNB | further UL transmissions scheduled |
| Channel Occupancy Time, the UE | by the scheduling DCI using the |
| may transmit the further UL | Type 2 channel access procedures |
| transmissions using the Type 1 | or the Type 2A UL channel access |
| channel access procedure, without | procedures without applying a CP |
| applying a CP extension. | extension if the further UL |
| | transmissions are within the gNB |
| | Channel Occupancy Time. |
| for all PUCCH transmissions unless | in case a DL grant indicates use of Type |
| otherwise stated. | 2 channel access procedures, where |
| | the DL grant is used by the UE to report |
| | a HARQ back to the gNB, or |
| | where a random access response |
| | (RAR) message for successRAR |
| | schedules a PUCCH transmission |
| for PRACH transmissions and PUSCH | |
| transmissions without user plane data | |
| related to a random access procedure | |
| that initiate a channel occupancy | |

As mentioned above, user devices may communicate directly with each other using the sidelink. In addition to implementing a sidelink communication in the licensed spectrum, also a sidelink communication may be implemented in the non-licensed or unlicensed spectrum. For example, one or more unlicensed subbands may be used for a sidelink communication between two user devices. Stated differently, the sidelink, in addition to being implemented in the licensed spectrum, may also be implemented in the unlicensed spectrum.

When implementing sidelink communications in the unlicensed spectrum, there is a need for improvements and enhancements so that a suitable channel access procedure, CAP, is selected which is to be performed by the SL UE prior to performing a transmission on the sidelink. The present invention addresses this need by allowing a sidelink, SL, UE to select the CAP to be used for evaluating an availability of resources in an unlicensed spectrum for performing an SL transmission based on whether certain criteria and/or conditions and/or scenarios apply.

In accordance with first embodiments, the UE may select the CAP to be used responsive to a corresponding indication by a network entity, for example, a base station when operating in Mode 1. This embodiment is advantageous because the network entity in Mode 1 controls the use of the resource pool and schedules other UEs to use the resources within the pool. Assuming that the gNB also has some information about the availability of the resources being used by other non-3GPP RATs, the gNB has a bird's eye view of the resource allocation and scheduling status of the resource pool, and is hence well-placed to indicate to the UE as to which type of CAP it needs to use in order to ensure that the UE may have a successful transmission. This is true even if the network entity does not have information regarding the usage status of the resource pool by other non-3GPP UEs, as long as the pool is used only by 3GPP UEs.

In accordance with second embodiments, the indication which CAP to use may be received from a network entity of the wireless communication network, e.g. a 3GPP network entity such as a base station, another SL UE, a network function, e.g., an entity provided by the core network, like the 5GC, a road side unit, RSU, or a relay device, or from a network entity of a different or further wireless communication network, e.g., a non-3GPP device, like a WiFi access point. The network entity provides the channel occupancy time, COT, to be shared with the transmitting UE for the SL transmission. This embodiment is advantageous because by initiating the COT sharing, the network entity is essentially reserving a subband for use between the network entity and the UE. It initiates the COT by performing CAP to decide the availability of the subband, and is hence capable of recommending the type of CAP to be performed by the UE before it uses the same subband.

In accordance with third embodiments, the UE may select the CAP dependent on whether a network entity of the wireless communication network, like a base station or anther SL UE, which provides a grant of resources for the sidelink transmission, has knowledge about the availability of the resources in the unlicensed spectrum for performing the SL transmission. The network entity providing the grant may also perform a sensing on the resources in the unlicensed spectrum, for example, in an unlicensed sidelink resource pool, SL-U RP. In addition or alternatively, the network entity may receive from other entities within a network their sensing results, for example, by using inter-UE coordination, IUC or from respective assistance information messages, AIMs, indicating which resources may be available/unavailable for a communication in the unlicensed spectrum. This embodiment is advantageous because as previously mentioned, the network entity has information regarding the occupancy status of the resource pool with respect to other non-3GPP UEs using the same set of resources. Since it uses this information when scheduling resources to the UE via the grant, the UE may have more confidence in the quality of the resources provided and that there is a minimal probability of causing resource collisions with other non-3GPP UEs.

In accordance with fourth embodiments, the CAP may be selected dependent on a type of SL physical, PHY, channel to be transmitted by the SL transmission. This embodiment is advantageous because based on the channel characteristics and the transmission to be carried out, the UE may decide on whether it needs to carry out longer duration CAPs to be sure about the occupancy of the resources being used, or shorter duration CAPs instead. For example, the UE needs to carry out longer duration CAPs for control and data transmissions of high priority SL transmissions in order to ensure reliability and minimize retransmissions, while it uses shorter duration CAPs to transmit the PSFCH since it is more time sensitive based on the remaining PDB.

In accordance with fifth embodiments, the CAP may be selected based on one or more certain characteristics of the SL transmission. This embodiment is advantageous because the objective of the UE is to attempt to carry out the transmission in possibly the first opportunity, or in the initial transmission itself, in the most reliable and latency efficient manner. By selecting the CAP based on the transmission characteristics, the UE may ensure that it does so, while at the same time increasing the resource efficiency by avoiding failed transmissions and multiple retransmissions.

In accordance with sixth embodiments, the UE may select the CAP dependent on a configuration of the resources in the unlicensed spectrum for performing the SL transmission. This embodiment is advantageous because initial transmissions and retransmissions or the first periodic transmission and subsequent transmissions may take place across different subbands. Providing the UE with the capability to select the CAP independently dependent on these factors enable the UE to minimize the duration of the CAP while ensuring successful transmissions.

In accordance with seventh embodiments, the CAP may be selected dependent on a structure of the resource pool of resources in the unlicensed spectrum for the SL transmission. This embodiment is advantageous because the UE has to ultimately ensure that the resources that it selects are indeed unoccupied by other non-3GPP UEs. When the resource pool configuration supports interlaces, for example, the UE has to ensure that it carries out CAP in each of the subbands or RB sets to check for their availability before transmitting. Selecting the CAP accordingly ensures successful transmissions.

In accordance with eighth embodiments, the CAP may be selected dependent on whether a transmission to be carried out using continuous or non-continuous resources over time within the SL-URP. This embodiment is advantageous because similar to the configuration of resources, resource pool configurations allow contiguous or non-contiguous frequency based subchannels and continuous or discontinuous time slots. By adapting the type of CAP used for each of these different resource pool configurations enable the UE to reduce the time spent on carrying our CAPs while ensuring successful transmissions.

In accordance with ninth embodiments, the CAP may be selected dependent on the presence of a transmission using a radio access technology, RAT, which is different from the RAT used by the UE for the SL transmission. This embodiment is advantageous because the UE may entirely avoid carrying out CAP if the resource pool is configured only for 3GPP UEs, ruling out any competition of resources with other non-3GPP UEs. The existing sensing mechanism is adequate to ascertain the availability of these resources.

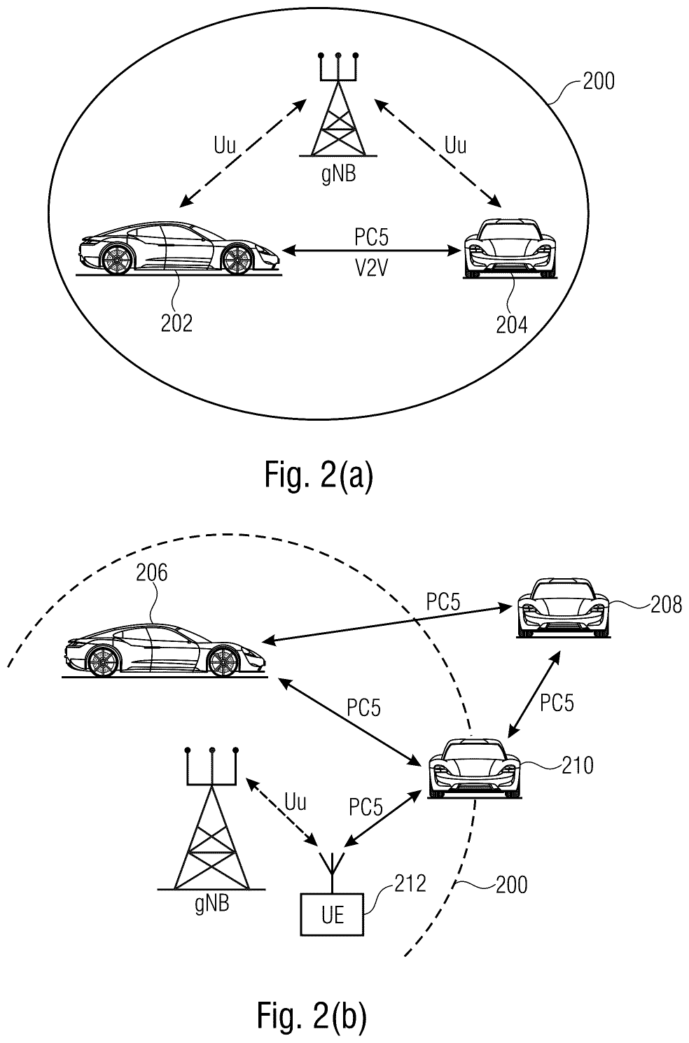

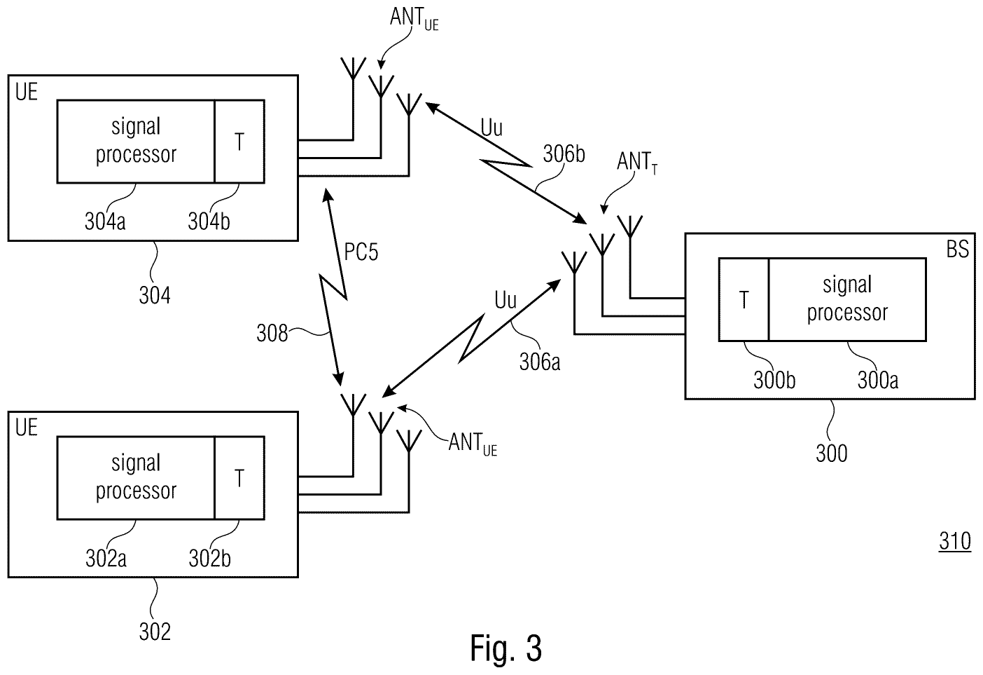

Embodiments of the present invention may be implemented in a wireless communication system as depicted in FIG. 1, FIG. 2(a) or FIG. 2(b) including base stations and users, like mobile terminals or IoT devices. FIG. 3 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 3, the one or more UEs 302, 304 of FIG. 3, and the base station 300 of FIG. 3 may operate in accordance with the inventive teachings described herein.

### User Device

The present invention provides a user device, UE, for a wireless communication network, like a 3rd Generation Partnership Project, 3GPP, network,
wherein the UE is to communicate with one or more further UEs in the wireless communication network over a sidelink, SL, using a set of resources in an unlicensed spectrum,
wherein, for performing a SL transmission on the set of resources in the unlicensed spectrum, the UE is to perform a channel access procedure, CAP, for evaluating an availability of the set of resources for performing the SL transmission,
wherein the UE is to select the CAP to be used for evaluating the availability of the set of resources for performing the SL transmission based on a criterion.

In accordance with embodiments, the criteria for selecting the CAP is one or more of:
an indication by a network entity of the wireless communication network or a further wireless communication network, or
an indication by a network entity of the wireless communication network which initiates a channel occupancy time, COT, to be shared with the UE for the SL transmission, or
whether a network entity of the wireless communication network, which provides a grant for a set of resources for the SL transmission, has knowledge about the availability of the set of resources in the unlicensed spectrum for performing the SL transmission, or
a configuration of the set of resources in the unlicensed spectrum for performing the SL transmission, or
one or more certain characteristics of the SL transmission, or
a type of a SL physical, PHY, channel to be transmitted by the SL transmission, or
a structure of a resource pool of a set resources in the unlicensed spectrum for the SL transmission,
a presence of a transmission using a radio access technology, RAT, being different from the RAT used by the UE for the SL transmission.

In accordance with embodiments, the UE is to receive from the network entity providing the COT information regarding the configuration of the COT, the information regarding the configuration of the COT indicating the CAP to be performed by the UE.

In accordance with embodiments, in case the network entity has knowledge about the availability of the resources, the UE is to do one or more of the following:
not perform a CAP, or
perform a CAP or a first CAP in case the SL transmission has one or more certain characteristics, and/or
either perform a second CAP or not perform a second CAP in case the SL transmission does not have the one or more certain characteristics, the first and second CAPs being different.

In accordance with embodiments, in case the network entity has no knowledge about the availability of the resources, the UE is to do one or more of the following:
perform a CAP, or
perform a first CAP in case the SL transmission has one or more certain characteristics, and to either perform a second CAP or not to perform a CAP in case the priority of the SL transmission does not have the one or more certain characteristics, the first and second CAPs being different.

In accordance with embodiments, the UE is to select the CAP dependent on whether the SL transmission transmits one or more of
a physical sidelink control channel, PSCCH,
a physical sidelink shared channel, PSSCH,
a physical sidelink feedback channel, PSFCH,
a physical sidelink broadcast channel, PSBCH,
a 1^{st} stage SCI,
a 2^{nd} stage SCI.

In accordance with embodiments, in case the SL transmission transmits a physical sidelink control channel, PSCCH, and/or a physical sidelink shared channel, PSSCH, the UE is to select the CAP dependent on one or more certain characteristics of the SL transmission.

In accordance with embodiments, in case the SL transmission transmits a physical sidelink feedback channel, PSFCH,
the UE is to perform a CAP, which provides for a quicker access or is of a shorter duration than a CAP used for a SL transmission transmitting on a channel different from the PSFCH, or
in case the UE does not find an available PSFCH time slot within a packet delay budget, PDB, of a TB of the SL transmission, the UE is to change from a currently used CAP to a new CAP, which provides for a quicker access or is of a shorter duration than the currently used CAP.

In accordance with embodiments, in case the SL transmission transmits a physical sidelink control channel, PSCCH, or a physical sidelink shared channel, PSSCH, in a first COT and a physical sidelink feedback channel, PSFCH, in a second COT, and in case resources in between the first and second COTs are used by a further UE using another COT,
the UE is to perform a first CAP for the transmission of the PSCCH or PSSCH and a second CAP for the transmission of the PSFCH, or
in case the UE is carrying out blind transmissions without feedback enabled, the UE is to carry out CAPs only for the PSCCH or PSSCH.

In accordance with embodiments, the one or more certain characteristics of the SL transmission comprise one or more of:
a priority of the SL transmission being equal to or above a configured or preconfigured threshold,
a packet delay budget, PDB, or latency of the SL transmission being equal to or above a configured or preconfigured threshold,
whether the SL transmission is a periodic transmission or an aperiodic transmission,
whether the SL transmission is an initial transmission or a retransmission, wherein the UE is to perform a first CAP or not perform a first CAP in case the SL transmission is an initial transmission, and to perform a second CAP in case the SL transmission is a retransmission,
whether the resources for the SL transmission were selected by a reevaluation procedure,
whether the resources for the SL transmission were selected by preemption,
a type of sensing used for a selection of the resources for the SL transmission, e.g., full-sensing, partial sensing, random resource selection,
whether the SL transmission is carried out in Mode 1 or Mode 2, based on the operational mode,
whether the SL transmission contains an inter-UE coordination, IUC, or an assistance information message, AIM,
whether the SL transmission is of a certain cast type, e.g., unicast, groupcast, or broadcast,
a location of the UE, a distance to a receiving UE, RX UE, a Minimum Communication Range, MCR, a zone in which the UE is located, e.g., zone ID,
a QoS profile of the SL transmission.

In accordance with embodiments, the one or more certain characteristics of the SL transmission comprise a priority of the SL transmission, wherein the UE is to perform a first CAP in case the SL transmission has a first priority, and to perform a second CAP in case the SL transmission has a second priority, the first and second priorities being different.

In accordance with embodiments, the one or more certain characteristics of the SL transmission comprise a priority of the SL transmission, wherein the UE is to perform a first CAP in case the SL transmission has a priority which is at or above a configured or preconfigured threshold, and to either perform a second CAP or not to perform a second CAP in case the SL transmission has a priority which is below the threshold.

In accordance with embodiments, the one or more certain characteristics of the SL transmission comprise a packet delay budget, PDB, of the SL transmission, wherein the UE is to either perform a first CAP or not perform the first CAP in case a PDB is at or above a configured or preconfigured threshold, and to perform a second CAP in case the PDB is below the threshold or not to perform a second CAP in case a PDB is at or above a configured or preconfigured threshold.

In accordance with embodiments, in case the first CAP is performed and fails, e.g., on a primary band, the UE is to perform the SL transmission on other resources, like another carrier or subchannel or subband or bandwidth part, in the licensed or unlicensed spectrum, by performing
a first or second CAP, in case of a transmission on an unlicensed set of resources, wherein the first CAP is the same as performed initially, e.g., on the primary band, and the second CAP is different from the first CAP, or
no CAP, in case of a transmission on a licensed set of resources.

In accordance with embodiments, the one or more certain characteristics of the SL transmission comprise a periodicity of the SL transmission, wherein
the UE is to perform a first CAP in case of an aperiodic SL transmission, and to perform a second CAP in case of a periodic SL transmission, or
the UE is to perform the same CAP for aperiodic SL transmissions or retransmissions,
the UE is to perform different CAPs for periodic SL transmissions so that for each transmission of a transport block, TB, a different CAP is used, wherein the CAPs are indicated by the resource reservation periodicity.

In accordance with embodiments, the one or more certain characteristics of the SL transmission comprise whether the SL transmission is an initial transmission or a retransmission on resources already reserved within a certain number of future time slots using a time resource indicator value, TRIV, and/or within a certain number of future frequency resources, e.g., subchannels, using a frequency resource indicator value, FRIV, wherein the UE is to perform a first CAP or no CAP in case the SL transmission is an initial transmission, and to perform a second CAP in case the SL transmission is a retransmission.

In accordance with embodiments, the one or more certain characteristics of the SL transmission comprise new resources to be used for the SL transmission following a re-evaluation or pre-emption of initial resources scheduled for the SL transmission, and wherein the UE is to perform a first CAP for checking the availability of the new resources which is quicker or of a shorter duration than a second CAP for checking the availability of the initial resources.

In accordance with embodiments, the one or more certain characteristics of the SL transmission comprise a type of sensing that the UE performs for determining resources available for the SL transmission, wherein
in case of a full sensing, the UE is not to perform a CAP or is to perform a CAP having a duration less than a certain configured or preconfigured threshold, like a minimum duration CAP, e.g., a type 2C CAP, or
in case of a partial sensing, the UE is to perform a CAP in case an amount of resources sensed by the UE is below a configured or preconfigured threshold, or
in case of a random resource selection, the UE is to perform a CAP.

In accordance with embodiments, the one or more certain characteristics of the SL transmission comprise an operational mode used for transmitting a TB of the SL transmission, wherein
in case of a Mode 1 transmission, the UE is not to perform a CAP or perform a CAP with a minimum duration if the gNB is aware of the availability of the resources provided to the UE,
in the case of a Mode 1 transmission, the UE is to perform a CAP if the gNB is not aware of the availability of the resources provided to the UE,
in case of a Mode 2 transmission, the UE is to decide whether to perform a CAP and the type of CAP to be performed dependent the one or more certain characteristics of the SL transmission.

In accordance with embodiments, the one or more certain characteristics of the SL transmission comprise whether the SL transmission contains inter-UE coordination, IUC, information, wherein
the UE is to perform a first CAP in case the SL transmission includes the IUC information and data, and
the UE is to perform a second CAP, which provides for a quicker access or is of a shorter duration than the first CAP, in case the SL transmission includes IUC information only.

In accordance with embodiments, the one or more certain characteristics of the SL transmission comprise whether the resources to be used for the SL transmission are obtained from an inter-UE coordination, IUC, message, wherein
the UE is not to perform a CAP, or
the UE is to perform a CAP depending on the priority or characteristics of the intended transmission, wherein the UE is to perform a CAP in case the SL transmission has a first priority or one or more certain characteristics, and to perform no CAP in case the SL transmission has a second priority or does not have the one or more certain characteristics, the first and second priorities being different, or
the UE is to perform a CAP indicated in the IUC message, or
the UE is to perform a CAP depending on whether the further UE that provided the IUC message to the UE performed a CAP, wherein the UE is to perform a first CAP in case the further UE had not performed CAP on the resources indicated in the IUC, and to not perform a CAP or perform a second CAP in case the further UE had already performed CAP on the indicated resources.

In accordance with embodiments, the IUC message contains one or more of
a set of preferred resources for a transmission over the SL,
a set of non-preferred resources for a transmission over the SL,
a collision indication.

In accordance with embodiments,
the one or more certain characteristics of the SL transmission comprise replacing initially selected resources for the SL transmission by new resources, e.g., by a resource reselection procedure performed by the UE, responsive to receiving an inter-UE coordination, IUC, message from another UE which includes a collision indicator or a large set of non-preferred resources, and
the UE is to perform a CAP that is different from the CAP that was used for the initially selected resources.

In accordance with embodiments, responsive to the IUC message, the UE is to perform one or more of the following actions:
aggregate another carrier,
switch to another licensed band,
switch to another unlicensed band,
drop the transmission.

In accordance with embodiments, the one or more certain characteristics of the SL transmission comprise a cast type of the SL transmission, wherein
in case of a unicast, the UE is to perform a first type of CAP having a first duration,
in case of a groupcast or a broadcast, the UE is to perform a second type of CAP having a second duration, the first duration being shorter or longer than the second duration.

In accordance with embodiments, the one or more certain characteristics of the SL transmission related to the location of the UE comprise one or more of the following:
a distance over which the SL transmission is to be transmitted, e.g., a distance between the UE and a further UE to which the SL transmission is directed, e.g., physical distance between the UEs,
a location from which the SL transmission originates, e.g., a location of the UE, e.g., a zone in which the UE is located or coordinates indicating the position of the UE, like longitude and/or latitude and/or height,
a minimum required communication range, MCR,
a path loss the SL transmission experiences when being transmitted, e.g., measured by a Signal to Noise Ratio, SNR, a Signal to Interference and Noise Ratio, SINR, a Receive Signal Strength Indicator, RSSI, or a Reference Signal Received Power, RSRP,
an identity, ID, of the given UE.

In accordance with embodiments, the configuration of the resources in the unlicensed spectrum comprises a plurality of resource sets, each of the plurality of resource sets being associated with a certain CAP to be used, and wherein a resource set comprises a bandwidth part or a resource pool or a subband or a subchannel or an aggregated carrier.

In accordance with embodiments, the UE is to receive the indication from the network entity responsive to a request by the UE via unicast or as a groupcast or broadcast, the indication including a configuration on how to initiate a COT or how to initiate a COT and future COTs.

In accordance with embodiments, the future COTs are one or more of
the next n future COTs, e.g., the next 5 COTs performed by the UE,
the next n future transmissions, e.g., COTs used for the next 5 transmissions,
the future COTs until a timer is reached, e.g., COTs for the next 100 milliseconds,
the future COTs until configured otherwise, e.g., responsive to a new configuration,
the future COTs until an event occurs, e.g., HARQ decoding failures reach a configured or preconfigured threshold or responsive to a certain IUC message.

In accordance with embodiments, dependent on whether or not a resource pool in the unlicensed spectrum available for the SL transmission supports interlacing, the UE is to perform
a first CAP for the SL transmission, in case the resource pool supports interlacing, or in case the SL transmission takes place across different interlaces,
a second CAP in case the resource pool does not support interlacing.

In accordance with embodiments, dependent on a similarity of current resources, which are used for a current SL transmission, and future resources, which are to be used for a future transmission or retransmission and which are already reserved within a certain number of future time slots using a time resource indicator value, TRIV, and/or within a certain number of future frequency resources, e.g., subchannels, using a frequency resource indicator value, FRIV, the UE is to perform
either no CAP or a first CAP for the future SL transmissions, in case the current resources and the future resources are in the same subband or sub channel, or
a second CAP for future SL transmissions, in case the current resources and the future resources are in the different resource block, RB, sets in different subbands or sub channels.

In accordance with embodiments, dependent on whether the SL transmission uses continuous or non-continuous resources within a resource pool in the unlicensed spectrum available for the SL transmission, the UE is to perform
a first CAP or no CAP for the SL transmission, in case the resources are continuous, or
a second CAP for the SL transmission, in case the resources are non-continuous.

In accordance with embodiments, dependent on the presence of a transmission using a radio access technology, RAT, being different from the RAT used by the UE for the SL transmission, the UE is to perform
a first CAP or no CAP for the SL transmission, in case a subband, sub channel or resource pool for the SL transmission is assigned only for the RAT used by the UE for the SL transmission, or
a second CAP for the SL transmission, in case a subband, sub channel or resource pool for the SL transmission is shared by different RATs, or
no CAP in case of semi-static subband, sub channel or resource pool definitions.

In accordance with embodiments, the CAP, which the UE is expected to perform, includes one or more to the following:
a Listen-Before-Talk, LBT, procedure on the resource,
a detection of one or more energy levels on the resource, e.g., a Received Signal Strength Indication, RSSI, a Signal to Noise Ratio, SNR, or a Signal to Noise Interference Ratio, SINR,
a measurement of pilot symbols transmitted on the resource and/or a determination of one or more measured values, e.g., a 3GPP Reference Signal Receive Power, RSRP, or a 3GPP Reference Signal Received Quality, RSRQ,
a decoding of a sidelink assistance information message, SL AIM,
a decoding of a sidelink inter-UE coordination message, IUC,
a decoding of an assistance information message, AIM,
a decoding of control messages transmitted on the resource, e.g., 3GPP downlink control information, DCI, or 3GPP sidelink control information, SCI, or an IEEE 802.11 Physical Layer Convergence Protocol, PLCP, header, or an extraction of information on one or more transmissions, like ongoing or upcoming transmissions or a remaining duration of an ongoing transmission.

In accordance with embodiments, the LBT procedure comprises:
a type-1 CAP that senses a channel for the SL transmission for a random time duration, or
a type-2A CAP that senses a channel for the SL transmission for 25 μs, or
a type-2B CAP that senses a channel for the SL transmission for 16 μs,
a type-2C CAP that does not sense a channel for the SL transmission, or
a new type of CAP that senses a channel for the SL transmission with a configured or preconfigured time duration.

In accordance with embodiments, the CAP evaluates, based on sensing, an availability of a channel for performing the SL transmissions, wherein a certain duration of the channel is considered to be idle when the channel is sensed during the certain duration and when it is determined that a detected power for at least a certain time within the certain duration is less than an energy detection threshold, otherwise, the channel is considered to be busy.

In accordance with embodiments, the difference between the first CAP and the second CAP is dependent on the duration of the LBT, sensing or measurement that the UE has to perform to decide whether a resource is occupied by further UEs or not.

In accordance with embodiments, the network entity is one of
a base station, or
a further UE, or
a network function, e.g., an entity provided by the core network, e.g., 5GC, or
a non-3GPP device, e.g., a WiFi access point, or
an RSU or a relay device.

### System

The present invention provides a wireless communication system, like a 3rd Generation Partnership Project, 3GPP, system, comprising a one or more of the inventive user devices, UEs and one or more base stations.

In accordance with embodiments,
the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a SL UE, or a vehicular UE, or a vehicular group leader UE, GL-UE, or a scheduling UE, S-UE, or an IoT or narrowband IoT, NB-IoT, device, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity, and
the base station comprises one or more of a macro cell base station, or a small cell base station, or a central unit of a base station, or a distributed unit of a base station, or an Integrated Access and Backhaul, IAB, node, or a road side unit, RSU, or a UE, or a SL UE, or a group leader UE, GL-UE, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

### Method

The present invention provides a method for operating a user device, UE, for a wireless communication network, like a 3rd Generation Partnership Project, 3GPP, network, the method comprising:
communicating, by the UE, with one or more further UEs in the wireless communication network over a sidelink, SL, using a set of resources in an unlicensed spectrum,
for performing a SL transmission on the set of resources in the unlicensed spectrum, performing, by the UE, a channel access procedure, CAP, for evaluating an availability of the set of resources for performing the SL transmission,
selecting, by the UE, the CAP to be used for evaluating the availability of the set of resources for performing the SL transmission based on a criterion.

### Computer Program Product

Embodiments of the first aspect of the present invention provide a computer program product comprising instructions which, when the program is executed by a computer, causes the computer to carry out one or more methods in accordance with the present invention.

Embodiments of the inventive aspect are now described in more detail with reference to the accompanying drawing. It is noted that the subsequently outlined and described aspects or embodiments may be combined such that some or all of the aspects/embodiments are implemented within one embodiment. Further, it is noted that when referring to “resources”, in this description, a resource is to be understood as comprising one or more of the following:
one or more symbols,
one or more time slots or subframes or frames,
one or more frequencies or carriers or subchannels or group of subchannels,
one or more frequency bands, like unlicensed subbands,
one or more bandwidth parts,
one or more resource pools,
one or more LBT sub-bands,
one or more spatial resources, e.g., using spatial multiplexing.

Furthermore, it is noted that when referring to “a set of resources”, in this description, a set of resources may contain one or more than one resource, with the definition of a resource as mentioned above.

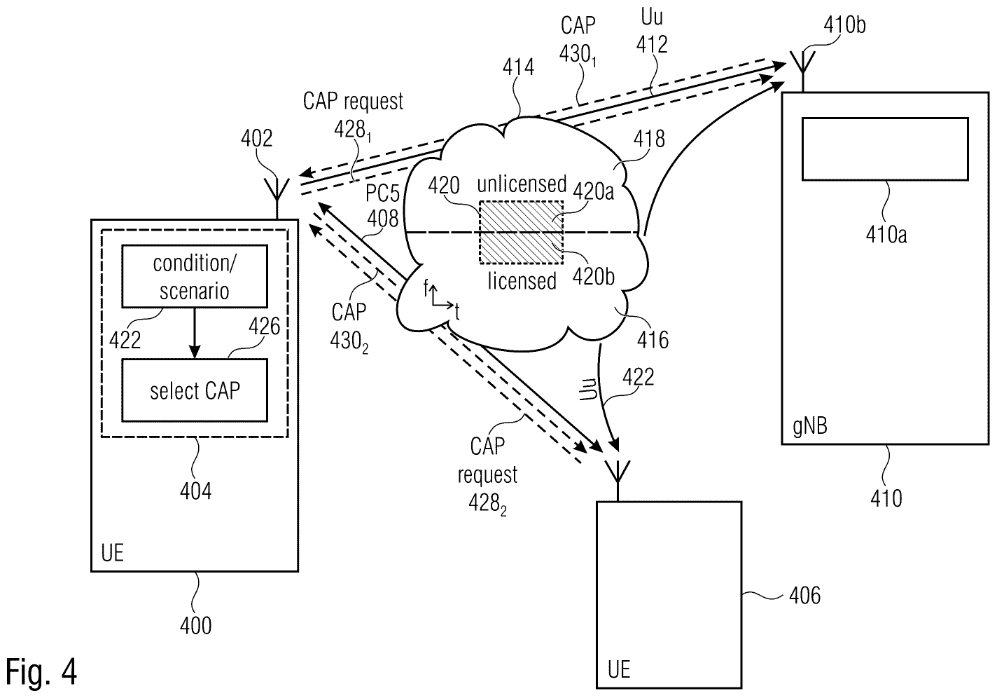

FIG. 4 illustrates a user device, UE, in accordance with an embodiment of the present invention. The UE, also referred to as sidelink UE, SL-UE, 400 comprises one or more antennas 402 and a signal processor 404 for performing one or more operations, for example operations involving the antenna 402, like transmitting/receiving data, like payload data or control data, or inter UE coordination (IUC) messages. UE 400 is operated in a wireless communication system, like the one described above with reference to FIG. 1 to FIG. 3, for example a 3^{rd} generation partnership project, 3GPP, system or network. UE 400 is to communicate with other UEs, like UE 406, using the sidelink or PC5 interface, as is schematically illustrated at 408. Moreover, UE 400 may connected to a base station or gNB 410. The gNB 410 includes a signal processor 410a and one or more antennas 410b for the wireless communication with the other network entities, like UEs 400 and 406. When operating in Mode 1, UE 400 receives via the Uu interface 412 resources allocated by the gNB 410 that are to be used by the UE 400 for the communication over the sidelink 408. As mentioned above, when operating in Mode 2, UE 400 may not have a connectivity to the gNB 410 and performs a sensing & access resource allocation or a random access-based resource allocation, e.g., when transmitting to UE 406.

FIG. 4 further illustrates, schematically, the spectrum 414, like the radio spectrum including the resources to be used for a communication within the wireless communication system or network. The resources available for the SL communication may comprise one or more of the following: one or more symbols, one or more time slots or subframes or frames, one or more resource blocks (RBs) or frequencies or carriers or subchannels or group of subchannels, one or more frequency bands. As is further illustrated, schematically, the spectrum 414 comprises the licensed spectrum 416 and the unlicensed spectrum 418. The licensed spectrum 416 is the part of the spectrum that is reserved for the wireless communication system including the UEs 400 and 406 as well as the base station 410. In other words, resources in the licensed spectrum are for exclusive use by this wireless system, as defined by regulatory bodies and entities. The unlicensed spectrum 418 includes resources that may be used by a plurality of wireless communication systems, for example by another wireless communication system in accordance with the 3GPP standard but operated by a different operator, or by systems using a different radio access technology, like WiFi or Bluetooth.

In accordance with embodiments, for the sidelink communication a resource pool 420, also referred to as sidelink resource pool, SL-RP, may be provided, and the UE 400 is configured or preconfigured with the resource pool 420. Although the figure depicts only a single resource pool, multiple such resource pools may be configured or preconfigured. The resource pool may include resources from the unlicensed spectrum 418 only or from the licensed spectrum 416 only, or, as is depicted in the embodiment of FIG. 4, may comprise resources from the licensed spectrum 416 and from the unlicensed spectrum 420. In accordance with further embodiments, the resources in the unlicensed spectrum may be aggregated using carrier aggregation.

In accordance with embodiments of the present invention, UE 400, before performing a transmission over the sidelink 408 using resources from the unlicensed spectrum 420a, may be required to carry out a suitable channel access procedure, like one of the channel access procedures, CAPs, described above. In accordance with the inventive approach, initially, UE 400, as indicated at 422, determines whether a certain criterion and/or condition and/or a certain scenario applies and, dependent on this determination, selects, as is indicated at 426, a CAP to be used. It is noted that selecting the CAP may also include that it is determined that no CAP is needed. Once the CAP is selected, for performing a desired SL transmission on the resources in the unlicensed spectrum, UE 400 performs the selected channel access procedure so as to evaluate the availability of resources in the unlicensed spectrum that may be used for performing the SL transmission, for example, the SL transmission over the sidelink 408 to UE 406.

### First Embodiment

In accordance with first embodiments of the present invention, UE 400 selects the CAP to be used based on an indication by a network entity of the wireless communication network. For example, the base station or gNB 410 may indicate to UE 400 the CAP to be used when UE 400 operates in Mode 1. For example, the gNB 410 may include the CAP to be used together with the grant of resource in the unlicensed spectrum to be used for the SL transmission. The CAP to be used may be part of the grant or may be signaled separately from the actual grant. In case of UE 400 operating in Mode 2, the CAP may be signaled by UE406. For example, in Mode 1, the gNB 410 may provide a configured or dynamic grant to the UE 400. In the case of the configured grant, which is provided using RRC signaling via RRC information elements, the gNB 410 may also include a parameter indicating the type of CAP that the UE has to use. Similarly, when the dynamic grant is provided to the UE 400 using downlink control information, DCI, signaling, the gNB 410 may also include a similar parameter regarding which type of CAP the UE uses for the resources included in the grant.

### Second Embodiment

As has been described above, during the channel occupancy time, COT, the network entity which performed a channel access procedure may share the channel occupancy with other entities of the wireless communication network. In accordance with second embodiments of the present invention, the network entity providing the COT, for example the gNB 410 or the further SL UE 406 may provide information regarding the COT configuration to UE 400. This information may include the type of CAP UE 400 is to use. In other words, based on the gNB 410 or the UE 406 originating the COT, so called COT sharing information may be provided to UE 400 which indicates which CAP UE 400, which makes use of the COT of the other entity, is to perform.

FIG. 4 illustrates how a CAP may be configured, for example via the gNB 410 or via the other UE 406. The CAP may include just the type of CAP that the UE has to use for a set of resources, a configuration on how to initiate a COT or it may comprise a COT and an accompanying configuration/instruction how to configure future COTs for a given UE. As indicated at 4281 a CAP configuration may be requested by UE 400, for example using a CAP request, from gNB 410 in case UE 400 operates in Mode 1. gNB 410 may broadcast to all UEs the CAP to be used, as is indicated at 4301 in FIG. 4. In case UE 400 operates in Mode 2 but manages to read a broadcast channel from gNB 410, the CAP to be used may be received from the gNB 410 as is indicated at 4301. On the other hand, in case UEs 400 and 406 operate in Mode 2 without connectivity to the gNB 410, as described above with reference to FIG. 2(b), UE 406 may receive a CAP configuration from UE 400 by using inter-UE coordination, IUC. For example, UE 406 may request UE 400 for the CAP, as it is indicated at 4282 and, in response, receive from UE 400 the CAP to be used as it is indicated at 4302.

For example, the UE may receive the indication from the network entity responsive to a request by the UE via unicast or as a groupcast or broadcast, and the indication may include a configuration on how to initiate a COT or how to initiate a COT and future COTs. The future COTs may be one or more of
the next n future COTs, e.g., the next 5 COTs performed by the UE,
the next n future transmissions, e.g., COTs used for the next 5 transmissions,
the future COTs until a timer is reached, e.g., COTs for the next 100 milliseconds,
the future COTs until configured otherwise, e.g., responsive to a new configuration,
the future COTs until an event occurs, e.g., HARQ decoding failures reach a configured or preconfigured threshold or responsive to a certain IUC message.

In other embodiments, UE 400 may broadcast the CAP which is then received by UE 406 without the need for sending the request 4282. In case of sending the CAP without a request, the CAP may be piggybacked on another message transmitted by UE 400.

In accordance with other embodiments, UE 400 may simply transmit the CAP to the surrounding UEs, similar to a polling message, so as to support the surrounding UEs with regard to the type of access procedure to be used for a certain part of the unlicensed spectrum, like a certain part of the resource pool to be used for the sidelink communication. In such a scenario, UE 400, which sends the CAP, may be a coordinating UE. It is noted that UE 400 is not necessarily a moving UE but may also be a stationary unit, like a roadside unit, RSU, which is provided to support in a coordination resources for a V2X communication.

### Third Embodiment

In accordance with third embodiments of the present invention, the UE may select the CAP dependent on whether a network entity of the wireless communication network, which provides the grant of resources for the sidelink communication, has or has no knowledge about the availability of the resources in the unlicensed spectrum for performing the SL transmission. For example, in case the network entity has knowledge about the availability of the resources, the UE may perform no CAP. According to other examples, the UE may perform different CAPs dependent on whether the SL transmission has or has not one or more certain characteristics. In other words, the UE may perform a CAP, like a first CAP of a longer duration, in case the SL transmission has one or more certain characteristics, and either perform or not perform a further CAP, like a second CAP of a shorter duration, different from the first CAP, in case the SL transmission does not have the one or more certain characteristics.

For example, if the network entity has knowledge of the availability of resources, and provides resources for an initial transmission that the UE immediately uses, then the UE need not carry out a CAP for the initial transmission. However, since the resources for retransmission are scheduled at later time slots, the UE has to carry out some type of CAP.

In accordance with other embodiments, in case the network entity has no knowledge about the availability of the resources, the UE may perform a CAP in any case. According to other examples, the UE may perform the CAP dependent on whether the SL transmission has or has not one or more certain characteristics. In other words, the UE may perform the CAP in case the SL transmission has one or more certain characteristics, otherwise, in case the SL transmission does not have the one or more certain characteristics, the UE does not perform a CAP. Since the network entity has no knowledge about the availability and occupancy status of the resources with respect to other non-3GPP UEs using them, it is up to the UE to determine this dependent on the nature of the transmission it is intending to carry out. For example, the UE may perform a CAP with a longer duration for higher priority transmissions in order to ensure that the resources are indeed available, while it may choose to perform a CAP with a shorter duration for low priority transmissions. Similarly, if the remaining PDB of a transmission is small, or soon to be expiring, the UE may choose to perform a shorter CAP in an attempt to complete the transmission before the expiry of the PDB.

The network entity, like the gNB 410 or the UE 406 may carry out a sensing of the resources from the unlicensed spectrum to be included into the grant, thereby determining the availability of the resources for the transmission. In accordance with other embodiments, this information may be received at the respective network entity from other network entities using, for example, IUC or assistance information messages, AIMs, forwarding information about the availability of certain resources from the unlicensed spectrum as sensed by the other entities.

Thus, the gNB 410 or the UE 406 may have knowledge about the availability of the resources to be used for the transmission in the unlicensed spectrum on the basis of their own sensing results and/or from the information included in one or more AIMs.

In accordance with embodiments, if the gNB 410 or the UE 406 is capable to perform some sort of sensing and/or is capable of receiving reports from other network entities including, for example, information about resources that are occupied by other RATs, the gNB 410 or UE 400 may provide UE 400 with this capability. Responsive to receiving this information, UE 400 may determine that it is not necessary to carry out any CAP. In accordance with further embodiments, instead of not carrying out any CAP, UE 400 may link the decision to a certain property of the transmission to be performed, for example to the transmissions priority. For example, in case the transmission to be performed is of a high priority, i.e., has a priority exceeding a certain threshold, UE 400, despite the fact that the gNB 410 or UE 406 indicated that they have knowledge about the availability of the resources for the transmission, and has provided resources that have been sensed or checked to be available, may decide to perform for such high priority transmissions a certain CAP, like a Type-1 CAP described above, thereby improving the reliability of the transmission. On the other hand, for transmissions having a lower priority, for example a priority below the above-mention threshold, the reliability of the transmission may not be so important and UE 400 may decide that for such low priority transmissions no CAP is required. With regard to the just-mentioned threshold it is noted that the threshold may be configured or preconfigured at UE 400, or may be a resource pool configuration or a system-wide configuration.

In case the gNB 410 or the UE 406 indicate to UE 400 that they have no knowledge about the availability of the resources to be used for the transmission from the unlicensed spectrum, for example because they do not carry out any sensing and also do not rely on AIMs or any measurement reports from other UEs, UE 400 determines that it is necessary to carry out a CAP for each of the resources or channels indicated in the grant received from the gNB 410 or the UE 406. For example, dependent on a certain property of the transmission to be carried out, a certain type of CAP may be selected. For example, high priority transmissions, as described above, may require to carry out a Type-1 CAP while other transmissions, like transmissions with a lower priority or retransmissions of an initial transmission may carry out a Type-2 CAP.

It is to be noted that the different type of CAPs differ in the duration that the UE takes in order to carry out the LBT, sensing or measurement of the resources that the UE intends to use for its transmission. For example, a first CAP may be of a longer duration, like a Type 1 CAP, which is dependent on the Channel Access Priority Class (CAPC) table (see Table 4.2.1-1 from TS 37.213), while a second CAP may be of a shorter duration, like a Type 2 CAP, as mentioned previously.

### Fourth Embodiment

In accordance with sixth embodiments of the present invention, UE 400 may decide about the CAP to be used dependent on the physical, PHY, channel type transmitted by the SL transmission, i.e., whether the SL transmission transmits one or more of: a physical sidelink control channel, PSCCH, a physical sidelink shared channel, PSSCH, a physical sidelink feedback channel, PSFCH, and a physical sidelink broadcast channel, PSBCH. It may also depend on the type of transmission being carried out in these channels, i.e., a 1st stage SCI on the PSCCH or a 2nd stage SCI on the PSSCH. In case the SL transmission transmits a physical sidelink control channel, PSCCH, and/or a physical sidelink shared channel, PSSCH, the UE may select the CAP dependent on one or more certain characteristics of the SL transmission. For example, if UE 400 is transmitting a PSCCH or a PSCCH, UE 400 may carry out a type-1 CAP for transmissions having a certain property, like a high priority, and otherwise use a type-2 CAP, for example for transmissions with a lower priority.

In accordance with embodiments, if UE 400 is transmitting a physical sidelink feedback channel, PSFCH, the UE performs a CAP, e.g. a type-2 CAP, which provides for a quicker access or of a shorter duration than a CAP, e.g., a type-1 CAP, used for a SL transmission transmitting on a channel different from the PSFCH, like on the PSCCH or PSCCH. In case the UE does not find an available PSFCH time slot within a packet delay budget, PDB, of a TB of the SL transmission, the UE may change from a currently used CAP to a new CAP, which provides for a quicker access than the currently used CAP, like from a type-2A or type-2B CAP to a type-2C CAP. The advantage of the UE being able to change the CAP depending on the PDB is that it may select a shorter duration CAP, like a type 2C CAP that only requires the UE to wait before accessing the channel or resource, as compared to a type 2A CAP that expects the UE to perform LBT before accessing the channel or resource.

In accordance with embodiments, UE 400 is expected to carry out CAPs independently for the transmission of each PSCCH or PSSCH and for the respective PSFCHs for this transmission, in case they belong to different COTs and in case the resources in between are used by a different UE using another COT. The reason behind this is because different COTs may point to different subbands, which means different resources on a different subchannel. Hence the UE performing CAP on one COT has no indication about the availability of resources on another COT. For example, if the UE performed a type 1 CAP for the control and data transmission on the PSCCH and PSSCH on one COT, the UE may choose to perform a type 2C CAP for the transmission of the feedback over another COT.

In case UE 400 is carrying out blind transmissions without feedback enabled, UE 400 is expected to carry out CAPs only for the PSCCH/PSCCH. This is because for blind transmissions, the UE does not have to transmit any feedback for this transmission, and hence does not need to access the PSFCH.

### Fifth Embodiment

In accordance with fifth embodiments of the present invention, UE 400 may decide about the CAP to be used dependent on one or more characteristics of the SL transmission to be performed.

In accordance with embodiments, a priority of the transmission may be mapped to the channel access procedure class, CAPC, table. The CAPC table (see Table 4.2.1-1 from TS 37.213) provides a mapping between the contention window sizes for different transmissions having a priority value ranging from 1 to 4. Assuming that these priority values are mapped to the PQI priority values ranging from 1 to 8, each of the transmissions may be assigned a range of contention window sizes. Depending on each of the priorities, the UE may choose to perform a different type of CAP with varying durations. For example, a high priority transmission with a priority value mapped to Channel Access Priority Class 1 has a contention window size ranging from 3 to 7. This determines the duration that the UE has to perform LBT or sensing in order to determine the availability of a given resource. Hence a longer duration enables the UE to concretely determine the availability of a resource.

In accordance with embodiments, the packet delay budget, PDB, of the transmission to be performed may be mapped to a remaining COT timer.

In accordance with embodiments, the CAP may be determined dependent on whether the SL transmission is an aperiodic transmission or is part of a number of periodic transmissions. For example, UE 400 may use the same CAP for aperiodic transmissions, i.e., for respective single or one-time transmissions, and apply the same CAP also in case a retransmission is needed. In accordance with other embodiments, UE 400 may use different CAPs for periodic transmissions, and the CAPs may be indicated by the resource reservation periodicity with one CAP to be used for each transmission of a transport block, TB.

In accordance with embodiments, the CAP may be selected based on whether the transmission is in an initial transmission or a retransmission on future resources which may be already reserved using, e.g., a time resource indicator value, TRIV, or a frequency resource indicator value, FRIV. In such a situation, the UE may use different CAPs for the initial transmission and for the retransmissions.

In accordance with embodiments, UE 400 may select the CAP based on whether the resources to be used for the transmission have been selected following a re-evaluation or pre-emption of initially selected resources. For example, UE 400 may have used a first type of CAP, like a type-1 CAP, for accessing initially determined resources for the transmission. However, it may turn out that the resources were either pre-empted or required a re-evaluation. In such a scenario, the UE, with regard to the resources to be used for the transmission following the re-evaluation/pre-emption makes use of a CAP that allows checking the availability of the resources or channel more quickly than the CAP used for checking the availability of the initial resources, for example a type 2-CAP of a shorter duration.

In accordance with embodiments, the CAP to be used may be selected dependent on a type of sensing carried out by the UE for determining the resources to be used for the transmission. Dependent on whether the resource selection has been carried out as a full, partial or random resource selection, different types of CAPs may be used.

In accordance with embodiments, the CAP may be determined based on an operational mode of UE 4000 when transmitting a transport block, TB, of a transmission. For example, dependent on whether the UE operates in Mode 1 (see FIG. 2(a)) or in Mode 2 (see FIG. 2(b)), different CAPs may be selected.

In accordance with embodiments, the CAP may be selected dependent on whether the transmission includes IUC information, for example an AIM. UE 400 may use the same CAP as for the data being transmitted with the IUC. In case the IUC is transmitted on its own, the UE may use a separate or different type of CAP allowing for a faster access to the resources, like a type-2 CAP.

In accordance with embodiments, UE 400 may decide the CAP dependent on whether it makes use of resources it obtained from an IUC message, like an AIM. For example, when receiving an IUC message from UE 406, UE 400 assumes that UE 406 performed some type of CAP before providing the IUC information and therefore may decide not to carry out any CAP or to carry out a CAP only for transmissions having a certain property, like a certain priority, as already explained earlier. In case UE 406 performed a type-1 CAP before providing the IUC information, UE 400 may decide to use a type 2C CAP.

In accordance with embodiments, UE 400 may signal UE 406 a type of CAP that UE 400 used for indicating the IUC message or AIM to UE 406.

In accordance with embodiments, UE 400 may determine the CAP to be used depended on the cast type, like a groupcast, unicast or broadcast.

In accordance with embodiments, UE 400 may determine the CAP to be used depended on the location of the UE 400, its distance from a receiving UE, the minimum communication range or the zone it is located in.

In accordance with embodiments, UE 400 may determine the CAP to be used depended on the QoS profile attached to the transmission that it intends to carry out.

In the just described embodiments, reference has been made to the one or more certain characteristics of the SL transmission. The one or more certain characteristics of the SL transmission comprise one or more of:
A priority of the SL transmission being equal to or above a configured or preconfigured threshold.
If the SL transmission is a high priority transmission (priority≥threshold), the UE may use a type 1 CAP to ensure that the resource is indeed available, and avoid retransmissions. If the SL transmission is a low priority transmission (priority<threshold), the UE may use type 2 CAP or even no CAP at all. This is because the UE needs to ensure the availability of a resource before transmitting a high priority transmission in order to avoid any resource collisions and at the same time reduce or entirely avoid retransmissions. This is to increase the performance and resource efficiency of the system. On the other hand, a low priority transmission may perform CAP with smaller durations or avoid it completely even if a retransmission has to be carried out in case of LBT failures. In other words, the low priority transmissions may be seen as a best-effort transmission with the available resources, while taking into consideration that even if the low priority transmission fails, the higher layers may handle retransmissions or packet losses. Such an action may not adversely affect the end to end performance of the system because it is of low priority. In a highly congested system, low priority transmissions are subject to more LBT failures and have a reduced performance.
There may also be an alternative view where the high priority transmissions use smaller duration CAPs in order to ensure a faster channel access and reduce latency, when compared to low priority transmissions.
A packet delay budget, PDB, or latency of the SL transmission being equal to or above a configured or preconfigured threshold.
For example, in the case that the remaining PDB is small, meaning that there isn't much time left for the UE to attempt to complete the transmission, the UE may choose to not perform a CAP and simply transmit, or perform only a type-2C CAP.
On the other hand, in the case that there is adequate time left for completing the transmission, the UE may carry out a longer duration CAP, like a type-1 CAP.
In case a first CAP is performed and fails, e.g., on a primary band, the UE is to perform the SL transmission on other resources, like another carrier or subchannel or subband or bandwidth part, in the licensed or unlicensed spectrum. In this case, the UE may perform a first or second CAP, in case of a transmission on unlicensed resources, with the first CAP being the same as performed initially, e.g., on the primary band, and the second CAP being different from the first CAP. In case of a transmission on licensed resources, no CAP is performed.
Whether the SL transmission is a periodic transmission or an aperiodic transmission.
For example, in the case of periodic transmissions, currently, the resource reservation period indicates when the next periodic TB is to be transmitted, within the same sub channel and resource pool. If the periodicity is less than a preconfigured or configured threshold, meaning that the periodicity is low, the UE may ascertain that the next periodic resource is available from a previously carried out CAP belonging to the same COT and same subband. In this case, the UE may either avoid carrying out CAP for the subsequent TB, or carry out a type-2C CAP. On the other hand, if the periodicity is high, then the UE is expected to carry out a full CAP like type 1 to make sure the channel is available.
Whether the SL transmission is an initial transmission or a retransmission, wherein the UE performs a first CAP or not perform a first CAP in case the SL transmission is an initial transmission, and to perform a second CAP in case the SL transmission is a retransmission.
For example, if the transmission is an initial transmission and the resources were provided by the gNB (Mode 1-see FIG. 2(a)) which has some sort of awareness about the availability status of resources, then the UE may avoid a CAP entirely or carry out only a type 2 CAP, e.g., type 2C. If the gNB has no awareness about the availability, then the UE may use type 1 or type 2. For Mode 2 (see FIG. 2(b)) initial transmissions, the UE carries out type 1, unless other characteristics like priority, PDB etc. take precedence. For retransmissions, since they were simply reserved in the future without any LBT check performed on these resources, the UE carries out type 1, unless other characteristics take precedence.
Whether the resources for the SL transmission were selected by a reevaluation procedure and/or by preemption.
Since the UE carries out these processes for resource selection before a predefined or defined time, the UE may carry out a type 2 CAP only, e.g., type 2C,
A type of sensing used for a selection of the resources for the SL transmission, e.g., full-sensing, partial sensing, random resource selection.
For example, in the case where the UE is performing full sensing, it is possible for the UE to avoid a CAP or carry out the minimum duration CAP like type 2C. This is because the UE is anyway carrying out proper sensing of the channel, and in the case where the unlicensed band is being used only by 3GPP RATS, then the sensing alone is enough to determine whether the resource is indeed available. Only if the band is shared with other RATs does the UE need to carry out a CAP like type 2C.
For partial sensing, the UE does not perform sensing in all the time slots, but only for a subset of them. In this case, the sensing results alone do not determine the availability of resources, and depending on the detection rate and priority, the UE may decide to either perform CAP type 1 or type 2. If the UE carried out sensing for most of the resources (high detection rate >threshold), then it may perform type 2 CAP. If the detection rate is low (<threshold), then the UE may perform type 1. This also applies for the priority, for high priority transmissions a type 1 CAP is performed to ensure resource availability.
For a random resource selection, since the UE does not perform sensing at all, the UE has to mandatorily carry out a CAP, preferably type 1. This may also be linked to priority or other transmission characteristics, i.e., dependent of the priority different types of CAPs may be applied.
Whether the SL transmission is carried out in Mode 1 or Mode 2, based on the operational mode.
For example, in Mode 1 (see FIG. 2(a)), the gNB provides the resources to the UE. If the gNB does some type of CAP (like a LBT or a selection of resources based on reports), the UE may avoid a CAP or carry out only a type 2 CAP. In Mode 2 (see FIG. 2(b)), it is up to the UE to carry out a CAP based on other transmission parameters like priority etc.
Whether the SL transmission contains an inter-UE coordination, IUC, or an assistance information message, AIM, or is based on resources indicated in an IUC message or in an AIM.
When referring to the UE as using resources obtained by IUC from another UE, the assumption is that the other UE carried out some type of CAP before sending the IUC. Hence, when receiving the IUC, the UE may either avoid carrying out CAP or may perform a type 2 CAP, e.g., depending on priority. For example, the UE is to perform a first CAP in case the SL transmission includes the IUC information and data, while it may only perform a second CAP, which provides for a quicker access than the first CAP, in case the SL transmission includes IUC information only. In accordance with embodiments, if the IUC is paired with data, it is possible for the UE to decide on which CAP to use based solely on the data transmission, since the IUC is technically piggybacked onto the data transmission. The UE may also perform a CAP depending on whether the another UE that provided the IUC message to the UE performed a CAP or not on the resources indicated in the IUC. In the case where the another UE has not performed a CAP, the UE has to perform a CAP of a longer duration, like a type 1 CAP, while in the case where the another UE did perform a CAP, the UE may avoid performing a CAP or perform a short duration CAP like a type 2 CAP.
The IUC message or AIM may contain one or more of: a set of preferred resources for a transmission over the SL, a set of non-preferred resources for a transmission over the SL, a collision indication. The collision indication may be as specified in Release 17, where a first UE detects a possible resource collision for a single future resource reserved by both a second and a third UE. The first UE then sends a collision indication to either the second or third UE, which may be only a 1 bit indication on the PSFCH informing the UE to not use the reserved resource. This may be considered essentially as a single non-preferred resource that the second/third UE has to avoid/not use.
In accordance with embodiments, initially selected resources for the SL transmission may be replaced by new resources, e.g., by a resource reselection procedure performed by the UE, responsive to receiving an IUC, message from another UE which includes a collision indicator or a large set of non-preferred resources. In such a situation, the UE performs a CAP that is different from the CAP that was used for the initially selected resources. The new CAP may be dependent on the transmission characteristics, like priority, PDB, etc. For example, responsive to the IUC message, the UE may perform one or more of the following actions: aggregate another carrier, switch to another licensed band, switch to another unlicensed band, drop the transmission
Whether the SL transmission is of a certain cast type, e.g., unicast, groupcast, or broadcast.
For example, in case of a unicast, the UE may perform a first type of CAP having a first duration, like a type 1 CAP, while in case of a groupcast or a broadcast, the UE may perform a second type of CAP having a second duration, like a type 2 CAP, with the first duration being shorter than the second duration.
A location of the UE, a distance to a receiving UE, RX UE, a Minimum Communication Range, MCR, a pathloss, a zone in which the UE is located, e.g., zone ID.
The distance may refer to a distance over which the SL transmission is to be transmitted, e.g., a distance between the UE and a further UE to which the SL transmission is directed, e.g., physical distance between the UEs.
The location may be a location from which the SL transmission originates, e.g., a location of the UE, e.g., a zone in which the UE is located or coordinates indicating the position of the UE, like longitude and/or latitude and/or height,
The pathloss may be a path loss the SL transmission experiences when being transmitted, e.g., measured by a Signal to Noise Ratio, SNR, a Signal to Interference and Noise Ratio, SINR, a Receive Signal Strength Indicator, RSSI, or a Reference Signal Received Power, RSRP.
The UE ID of the RX UE may be used, and the TX UE may identify its location using the zone information so as to allow the TX UE to determine its distance from the RX UE. The location, UE ID, and pathloss may be used to determine the distance between the UEs. On determining the distance between UEs, the TX UE may use a type 1 CAP if the distance is larger than a certain threshold, since the resources are prone to more interference, and need to check for availability of the resources. If the distance is shorter than the threshold (UEs are closer to each other), the UE may use type 2 CAPs, to determine the resource availability.
The MCR may be used for determining whether the RX UE has to transmit feedback to the TX UE. If the RX UE is within the MCR but the distance is still large, i.e., above the threshold, the UE performs a type 1 CAP, otherwise, if the RX UE is closer (distance less than the threshold), the TX UE may perform a type 2 CAP. For example, according to Release 16, the TX UE includes the MCR in the sidelink control information, SCI, requiring the RX UE to transmit feedback only if within the MCR indicated.

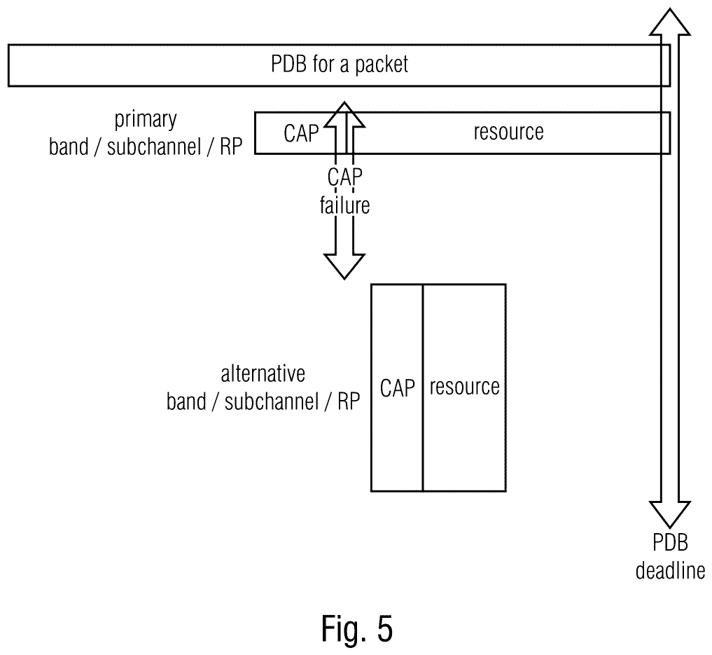

In accordance with certain embodiments, the UE may perform a first CAP. However, such a CAP may be unsuccessful or may fail. Therefore, in case a first CAP is performed and fails, e.g., on a primary band, the UE is to perform the SL transmission on other resources, like another carrier or subchannel or subband or bandwidth part, in the licensed or unlicensed spectrum. In this case, the UE may perform the first CAP or a second CAP, in case of a transmission on unlicensed resources, with the first CAP being the same as performed initially, e.g., on the primary band, and the second CAP being different from the first CAP. In case where the other resources for the transmission are licensed resources, no CAP is performed. FIG. 5 illustrates an embodiment how a failed initial CAP may be handled for a data transmission over the SL having a certain PDB. The following also applies for other properties or characteristics of the SL transmission, like the above mentioned priority or cast type or data size or transmission or retransmission type or physical layer channel type etc. As is illustrated, a SL transmission for which the CAP failed on the unlicensed carrier may be transmitted on another
unlicensed carrier, e.g., where it might be easier to obtain channel access, e.g., by using different CAP type,
licensed carrier, e.g., where the UE does not need to compete with non-3GPP RATs, and thus might more easily get required resources, e.g., when operating in
   mode 1 using a grant from the base station, e.g., gNB, and
   mode 2 performing a random resource selection or full or partial sensing

### Sixth Embodiment

In accordance with fourth embodiments of the present invention, UE 400 may determine a certain configuration of the resources in the unlicensed spectrum which are configured to be used for performing a sidelink transmission. For example, UE 400 may decide the CAP to be used dependent on a configuration of a resource pool or a subband-level configuration as provided by the gNB 410 which, further, instructs UE 400 to use a particular type of CAP for a given resource pool, RP, or subband or for a given subchannel. This is because initial transmissions and retransmissions may take place across different subbands or resources. It is also possible for the first periodic transmission and subsequent periodic transmissions to also take place across different subbands or resources. Providing the UE with the capability to select the CAP independently for each of these transmissions dependent on the location of the resources may enable the UE to minimize the duration of the CAP while ensuring successful transmissions. For example, if the resources for different TBs of a periodic transmission take place in the same subband, the UE may perform a longer duration CAP for the first of these periodic transmissions and reduce the duration of the latter transmissions. On the other hand, if these periodic transmissions take place across different subbands, then the UE may perform longer duration CAPs for each of them to determine the resource availability, because the UE has no prior information about their availability.

### Seventh Embodiment

In accordance with seventh embodiments of the present invention, UE 400 selects the CAP to be used based on a resource pool structure, more specifically based on the structure of the resource pool 420 defining the unlicensed resources to be used for the SL transmission. In accordance with embodiments, if the resource pool supports interlacing, UE 400 carries out a type-1 CAP. When the resource pool supports interlaces, the RBs are not contiguous across frequency, but rather spread across different RB sets. Hence the UE has to carry out CAP for each of these interlaces to ensure that they are indeed available before transmission. If the resource pool does not support interlacing, but only continuous resource blocks in the resource pool or in case the transmission takes place across different interlaces, for example in case of PSFCH transmissions, UE 400 is to carry out a type 2-CAP. In this case, the RBs are contiguous and form a single sub channel (or sub band). Hence the UE needs to carry out CAP for this single sub channel to ensure resource availability before transmissions.

In case of periodic transmissions, as they may be indicated by the TRIV or FRIV, and in case the resources for the retransmissions or future transmissions are reserved in the same subband as the initial transmission, for the future transmission, the UE may carry out a type 2-CAP. On the other hand, if the resources for the future transmission are in a different subband or in a different resource block set, when considering a wide band transmission, UE 400 carries out a type-1 CAP for each of the resources before performing the transmissions.

The UE may perform either no CAP or a first CAP for the future SL transmissions, in case the current resources and the future resources are in the same subband. If the retransmissions are on the same sub band/subchannel as that of the initial transmission, then the UE may either avoid carrying out CAP, or perform a CAP with a shorter duration like type 2 for the retransmissions. This is because the UE already carried out type 1 CAP for the initial transmission. In accordance with other examples, the UE may perform a second CAP for future SL transmissions, in case the current resources and the future resources are in the different resource block, RB, sets across different subbands or subchannels. If the retransmissions are scheduled to be on different subchannels as compared to the initial transmission, the UE is expected to carry out type 1 CAP because it has no previous information regarding the availability of the subchannel that it may derive from the initial transmission since it took place in a different subchannel.

### Eighth Embodiment

In accordance with eighth embodiments of the present invention, UE 400 may decide about the CAP to be used dependent on whether a transmission to be carried out uses continuous or non-continuous resources within the SL-URP over time. For example, a continuous resource pool may be defined by setting a bit map to 1 at all positions so as to avoid breaks within a COT and avoiding UEs, for example which are from other RATs, to use the channel. The UE may perform a first CAP or no CAP for the SL transmission, in case the resources are continuous. If continuous, the UE may perform the CAP once and reuse the same sub band for the remainder of the COT without carrying out CAP. It may carry out the CAP depending on the transmission characteristics though (see above). The UE may perform a second CAP for the SL transmission, in case the resources are non-continuous. If discontinuous, the UE performs a CAP every time it accesses the channel, because in the gaps or discontinuous durations, UEs from other RATs may occupy the channel. Hence the UE has to carry out type 1 to ensure the resource availability before transmissions.

### Ninth Embodiment

In accordance with ninth embodiments of the present invention, UE 400 is to select the CAP dependent on the presence of other RATs. For example, in case a certain resource, like a subband, is assigned to be used only for the 3GPP sidelink communication in the unlicensed band, a first type of CAPs may be used, while another kind of CAPs may be used when the resources or subband is shared across different RATs. If the sub band/resource pool is used only by 3GPP RATs, then the UE may avoid CAP entirely since it is not competing with other RAT UEs. If the band is shared, then the UE has to carry out type 1 or 2 CAP since it is competing with other RAT UEs.

In accordance with embodiments, in case semi-static subband definitions are allowed, and the subband supports only 3GPP sidelink transmissions in the unlicensed band, the UE is not expected to carry out any CAP but is allowed to use conventional procedures for resource allocation. If the sub band/resource pool is used only by 3GPP RATs, then the UE may avoid CAP entirely since it is not competing with other RAT UEs

### General

Embodiments of the present invention have been described in detail above, and the respective embodiments and aspects may be implemented individually or two or more of the embodiments or aspects may be implemented in combination.

In accordance with embodiments, the CAP evaluates, based on sensing, an availability of a channel for performing the SL transmissions, wherein a certain duration of the channel is considered to be idle when the channel is sensed during the certain duration and when it is determined that a detected power for at least a certain time within the certain duration is less than an energy detection threshold, otherwise, the channel is considered to be busy. For example, one may sense within a certain set of carriers within a certain time duration, e.g., on 5 out of 10 carriers within a sub channel or subband the energy detected exceeds a certain threshold. This scheme may be pre-configured or configured by the network/base station and may also vary, depending on which band and/or numerology is used in a given band/subchannel/bandwidth part.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a network entity comprises one or more of the following: a macro cell base station, or a small cell base station, or a central unit of a base station, an integrated access and backhaul, IAB, node, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

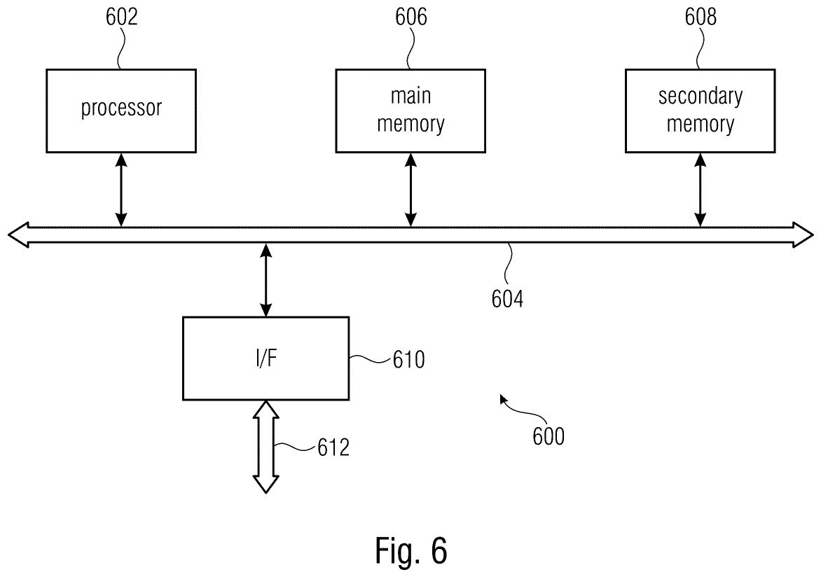

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 6 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the form of electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are preferably performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A user device, UE, for a wireless communication network, like a 3rd Generation Partnership Project, 3GPP, network,
wherein the UE is to communicate with one or more further UEs in the wireless communication network over a sidelink, SL, using a set of resources in an unlicensed spectrum,
wherein, for performing a SL transmission on the set of resources in the unlicensed spectrum, the UE is to perform a channel access procedure, CAP, for evaluating an availability of the set of resources for performing the SL transmission, and
wherein the UE is to select the CAP to be used for evaluating the availability of the set of resources for performing the SL transmission based on a criterion.

2. The user device, UE, of claim 1, wherein the criteria for selecting the CAP is one or more of:
an indication by a network entity of the wireless communication network or a further wireless communication network, or
an indication by a network entity of the wireless communication network which initiates a channel occupancy time, COT, to be shared with the UE for the SL transmission, or
a configuration of the set of resources in the unlicensed spectrum for performing the SL transmission, or
one or more certain characteristics of the SL transmission, or
a type of a SL physical, PHY, channel to be transmitted by the SL transmission, or
a structure of a resource pool of a set resources in the unlicensed spectrum for the SL transmission,
a presence of a transmission using a radio access technology, RAT, being different from the RAT used by the UE for the SL transmission.

3. The user device, UE, of claim 1, wherein, in case the network entity has knowledge about the availability of the resources, the UE is to do one or more of the following:
not perform a CAP, or
perform a CAP or a first CAP in case the SL transmission comprises one or more certain characteristics, and/or
either perform a second CAP or not perform a second CAP in case the SL transmission does not comprise the one or more certain characteristics, the first and second CAPs being different.

4. The user device, UE, of claim 1, wherein, in case the network entity has no knowledge about the availability of the resources, the UE is to do one or more of the following:
perform a CAP, or
perform a first CAP in case the SL transmission comprises one or more certain characteristics, and to either perform a second CAP or not to perform a CAP in case the priority of the SL transmission does not comprise the one or more certain characteristics, the first and second CAPs being different.

5. The user device, UE, of claim 1, wherein the one or more certain characteristics of the SL transmission comprise one or more of:
a priority of the SL transmission being equal to or above a configured or preconfigured threshold,
a packet delay budget, PDB, or latency of the SL transmission being equal to or above a configured or preconfigured threshold,
whether the SL transmission is a periodic transmission or an aperiodic transmission,
whether the SL transmission is an initial transmission or a retransmission, wherein the UE is to perform a first CAP or not perform a first CAP in case the SL transmission is an initial transmission, and to perform a second CAP in case the SL transmission is a retransmission,
whether the resources for the SL transmission were selected by a reevaluation procedure,
whether the resources for the SL transmission were selected by preemption,
a type of sensing used for a selection of the resources for the SL transmission, e.g., full-sensing, partial sensing, random resource selection,
whether the SL transmission is carried out in Mode 1 or Mode 2, based on the operational mode,
whether the SL transmission comprises an inter-UE coordination, IUC, or an assistance information message, AIM,
whether the SL transmission is of a certain cast type, e.g., unicast, groupcast, or broadcast,
a location of the UE, a distance to a receiving UE, RX UE, a Minimum Communication Range, MCR, a zone in which the UE is located, e.g., zone ID,
a QoS profile of the SL transmission.

6. The user device, UE, of claim 1, wherein the one or more certain characteristics of the SL transmission comprise a priority of the SL transmission, wherein the UE is to perform a first CAP in case the SL transmission comprises a first priority, and to perform a second CAP in case the SL transmission comprises a second priority, the first and second priorities being different.

7. The user device, UE, of claim 1, wherein the one or more certain characteristics of the SL transmission comprise a priority of the SL transmission, wherein the UE is to perform a first CAP in case the SL transmission comprises a priority which is at or above a configured or preconfigured threshold, and to either perform a second CAP or not to perform a second CAP in case the SL transmission comprises a priority which is below the threshold.

8. The user device, UE, of claim 1, wherein the one or more certain characteristics of the SL transmission comprise a packet delay budget, PDB, of the SL transmission, wherein the UE is to either perform a first CAP or not perform the first CAP in case a PDB is at or above a configured or preconfigured threshold, and to perform a second CAP in case the PDB is below the threshold or not to perform a second CAP in case a PDB is at or above a configured or preconfigured threshold.

9. The user device, UE, of claim 1, wherein, in case the first CAP is performed and fails, e.g., on a primary band, the UE is to perform the SL transmission on other resources, like another carrier or subchannel or subband or bandwidth part, in the licensed or unlicensed spectrum, by performing
a first or second CAP, in case of a transmission on an unlicensed set of resources, wherein the first CAP is the same as performed initially, e.g., on the primary band, and the second CAP is different from the first CAP, or
no CAP, in case of a transmission on a licensed set of resources.

10. The user device, UE, of claim 1, wherein the one or more certain characteristics of the SL transmission comprise whether the SL transmission is an initial transmission or a retransmission on resources already reserved within a certain number of future time slots using a time resource indicator value, TRIV, and/or within a certain number of future frequency resources, e.g., subchannels, using a frequency resource indicator value, FRIV, wherein the UE is to perform a first CAP or no CAP in case the SL transmission is an initial transmission, and to perform a second CAP in case the SL transmission is a retransmission.

11. The user device, UE, of claim 1, wherein the one or more certain characteristics of the SL transmission comprise a type of sensing that the UE performs for determining resources available for the SL transmission, wherein
in case of a full sensing, the UE is not to perform a CAP or is to perform a CAP comprising a duration less than a certain configured or preconfigured threshold, like a minimum duration CAP, e.g., a type 2C CAP, or
in case of a partial sensing, the UE is to perform a CAP in case an amount of resources sensed by the UE is below a configured or preconfigured threshold, or
in case of a random resource selection, the UE is to perform a CAP.

12. The user device, UE, of claim 1, wherein the one or more certain characteristics of the SL transmission comprise a cast type of the SL transmission, wherein
in case of a unicast, the UE is to perform a first type of CAP comprising a first duration,
in case of a groupcast or a broadcast, the UE is to perform a second type of CAP comprising a second duration, the first duration being shorter or longer than the second duration.

13. The user device, UE, of claim 1, wherein the one or more certain characteristics of the SL transmission related to the location of the UE comprise one or more of the following:
a distance over which the SL transmission is to be transmitted, e.g., a distance between the UE and a further UE to which the SL transmission is directed, e.g., physical distance between the UEs,
a location from which the SL transmission originates, e.g., a location of the UE, e.g., a zone in which the UE is located or coordinates indicating the position of the UE, like longitude and/or latitude and/or height,
a minimum required communication range, MCR,
a path loss the SL transmission experiences when being transmitted, e.g., measured by a Signal to Noise Ratio, SNR, a Signal to Interference and Noise Ratio, SINR, a Receive Signal Strength Indicator, RSSI, or a Reference Signal Received Power, RSRP,
an identity, ID, of the given UE.

14. The user device, UE, of claim 1, wherein the configuration of the resources in the unlicensed spectrum comprises a plurality of resource sets, each of the plurality of resource sets being associated with a certain CAP to be used, and wherein a resource set comprises a bandwidth part or a resource pool or a subband or a subchannel or an aggregated carrier.

15. The user device, UE, of claim 1, wherein the UE is to receive the indication from the network entity responsive to a request by the UE via unicast or as a groupcast or broadcast, the indication including a configuration on how to initiate a COT or how to initiate a COT and future COTs.

16. The user device, UE, of claim 1, wherein, dependent on the presence of a transmission using a radio access technology, RAT, being different from the RAT used by the UE for the SL transmission, the UE is to perform
a first CAP or no CAP for the SL transmission, in case a subband, sub channel or resource pool for the SL transmission is assigned only for the RAT used by the UE for the SL transmission, or
a second CAP for the SL transmission, in case a subband, sub channel or resource pool for the SL transmission is shared by different RATs, or
no CAP in case of semi-static subband, sub channel or resource pool definitions.

17. The user device, UE, of claim 1, wherein the CAP, which the UE is expected to perform, includes one or more to the following:
a Listen-Before-Talk, LBT, procedure on the resource,
a detection of one or more energy levels on the resource, e.g., a Received Signal Strength Indication, RSSI, a Signal to Noise Ratio, SNR, or a Signal to Noise Interference Ratio, SINR,
a measurement of pilot symbols transmitted on the resource and/or a determination of one or more measured values, e.g., a 3GPP Reference Signal Receive Power, RSRP, or a 3GPP Reference Signal Received Quality, RSRQ,
a decoding of a sidelink assistance information message, SL AIM,
a decoding of a sidelink inter-UE coordination message, IUC,
a decoding of an assistance information message, AIM,
a decoding of control messages transmitted on the resource, e.g., 3GPP downlink control information, DCI, or 3GPP sidelink control information, SCI, or an IEEE 802.11 Physical Layer Convergence Protocol, PLCP, header, or an extraction of information on one or more transmissions, like ongoing or upcoming transmissions or a remaining duration of an ongoing transmission.

18. The user device, UE, of claim 17, wherein the LBT procedure comprises:
a type-1 CAP that senses a channel for the SL transmission for a random time duration, or
a type-2A CAP that senses a channel for the SL transmission for 25 us, or
a type-2B CAP that senses a channel for the SL transmission for 16 μs,
a type-2C CAP that does not sense a channel for the SL transmission, or
a new type of CAP that senses a channel for the SL transmission with a configured or preconfigured time duration.

19. A wireless communication system, like a 3rd Generation Partnership Project, 3GPP, system, comprising a one or more user devices, UEs, and one or more base stations,
wherein the UE is to communicate with one or more further UEs in the wireless communication network over a sidelink, SL, using a set of resources in an unlicensed spectrum,
wherein, for performing a SL transmission on the set of resources in the unlicensed spectrum, the UE is to perform a channel access procedure, CAP, for evaluating an availability of the set of resources for performing the SL transmission, and
wherein the UE is to select the CAP to be used for evaluating the availability of the set of resources for performing the SL transmission based on a criterion.

20. A method for operating a user device, UE, for a wireless communication network, like a 3^{rd} Generation Partnership Project, 3GPP, network, the method comprising:
communicating, by the UE, with one or more further UEs in the wireless communication network over a sidelink, SL, using a set of resources in an unlicensed spectrum,
for performing a SL transmission on the set of resources in the unlicensed spectrum, performing, by the UE, a channel access procedure, CAP, for evaluating an availability of the set of resources for performing the SL transmission, selecting, by the UE, the CAP to be used for evaluating the availability of the set of resources for performing the SL transmission based on a criterion.
